(19) United States
(12) Patent Application Publication
(10) Pub. No.: US 2016/0153339 A1
(43) Pub. Date: Jun. 2, 2016

(54) EXHAUST MANIFOLD FOR VEHICLES

(71) Applicant: Hyundai Motor Company, Seoul (KR)

(72) Inventor: Dong Ho CHU, Ansan-si (KR)

(73) Assignee: Hyundai Motor Company, Seoul (KR)

(21) Appl. No.: 14/627,434

(22) Filed: Feb. 20, 2015

(30) Foreign Application Priority Data
Nov. 27, 2014 (KR) 10-2014-0167093

(51) Int. Cl. F01N 13/10; F01N 13/16; F02B 37/00

(52) U.S. Cl. CPC F01N 13/10; F02B 37/00; F01N 13/16; F01N 2260/20

(57) ABSTRACT

An exhaust manifold for vehicles may include a partition provided between a first junction where at least two of runners of the exhaust manifold leading to a cylinder join and a second junction where remaining runners join.

### CROSS-REFERENCE(S) TO RELATED APPLICATION

The present application claims priority of Korean Patent Application Number 10-2014-0167093 filed on Nov. 27, 2014, the entire contents of which application are incorporated herein for all purposes by this reference.

BACKGROUND

### Field of the Invention

The present invention relates to an exhaust manifold for vehicles, and more particularly, to the exhaust manifold for vehicles which prevents a crack occurring at an end portion of an exhaust port of the exhaust manifold due to continuous exposure to a hot exhaust gas.

Description of Related Art

Recently, a cylinder head integral with the exhaust manifold is increasingly used to apply a concept of downsizing of a gasoline turbocharger, and in particular, is often used for improving a fuel consumption rate in a high speed high load region.

In the cylinder head integral with the exhaust manifold, the cylinder head and the exhaust manifold are integrated, thereby raising a temperature of a cooling water by the exhaust manifold to raise a temperature of a combustion chamber, thereby capable of using a thinner fuel than the prior art to improve the fuel consumption rate in the high speed high load region.

However, this exhaust manifold, by being formed integrally with the cylinder head, has a disadvantage in that a length of a runner is shorten, thereby aggravating a low and medium speed performance due to a loss of an exhaust energy caused from an exhaust gas interference.

To solve a part of this problem, in case of a 4-cylinder engine, as shown in FIG. 1, among a first runner 101 to a fourth runner 104, the first runner 101 and the fourth runner 104 are connected and the second runner 102 and the third runner 103 are connected, thereby forming 4-2 type exhaust structure forming two exhaust ports at the end portion of the exhaust manifold, so as to increase the lengths of the runners and decrease the exhaust gas interference.

FIG. 2 is a view illustrating a section of an exhaust port as shown in FIG. 1, wherein a partition 105 is formed between portions where two exhaust ports meet.

However, this partition 105 has a problem that if the partition 105 is continuously exposed to the hot exhaust gas, a crack occurs starting at an end portion 105-1 due to a limitation of physical property of the exhaust manifold integral with a cylinder head 100 manufactured from aluminum.

To solve this problem, it can be considered to form a water jacket 106 close to the partition, however, it has a problem that, in current mold structure, it is difficult to construct the water jacket to be lengthened long, and it can also be considered to form the exhaust ports close to the water jacket, however, it also has a problem that the 4-2 type exhaust structure cannot be formed due to the limitation of the structure and the shape of the exhaust manifold.

In addition to these, the thickness of the partition can be increased compared to the prior art partition to improve the endurance of the partition, however in this case it has a problem that the sectional area of the exhaust port is decreased thereby to increase the exhaust gas resistance.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an exhaust manifold for vehicles which can prevent a crack occurring at an exhaust port due to continuous exposure to a hot exhaust gas.

In an aspect of the present invention, an exhaust manifold for vehicles may include a partition provided between a first junction where at least two of runners of the exhaust manifold leading to a cylinder join and a second junction where remaining runners join.

A reinforcing member is configured to form the partition to have a higher temperature endurance than a remaining exhaust manifold.

The reinforcing member forms the partition to have a material of the higher temperature endurance than that of the remaining exhaust manifold.

The partition is formed from a stainless steel or a cast iron, and the remaining exhaust manifold is formed from aluminum.

The partition is formed from a sheet material of the stainless steel or the cast iron.

The partition is formed integrally with the exhaust manifold.

A connector member is connected to an exhaust port, and the partition is formed at the connector member to be provided between the first junction and the second junction.

The partition is formed monolithically with the connector member.

The connector member is a turbocharger or a post-treatment device.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a cylinder head integrated with an exhaust manifold.

FIG. 2 is a view illustrating a section of a partition portion of FIG. 1.

FIG. 3 is a view illustrating a section of a partition portion in accordance with the present invention.

FIG. 4 is a view illustrating a construction in which the partition in accordance with the present invention is provided by a connector member.

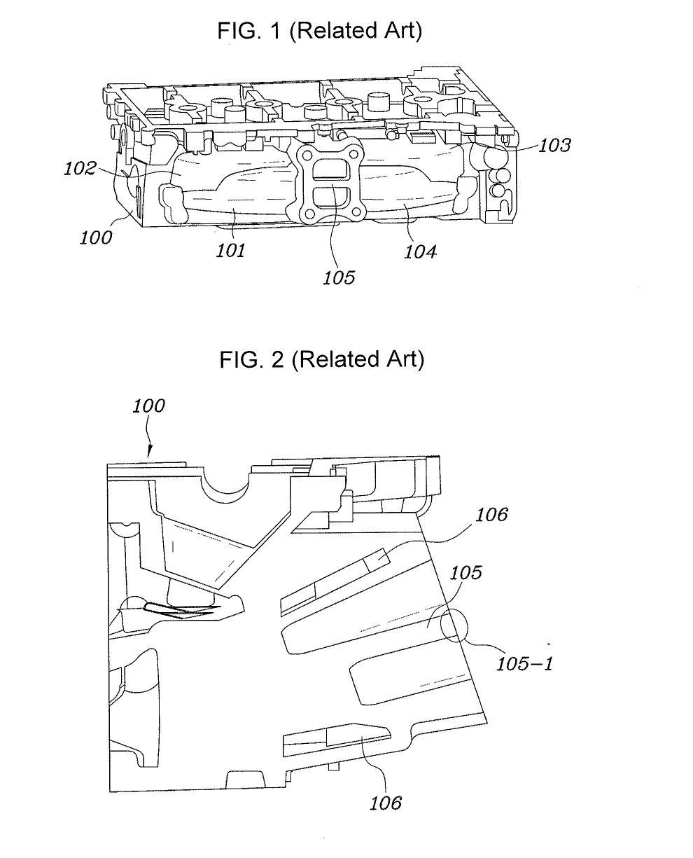

It should be understood that the appended drawings are not necessarily to scale, presenting a somewhat simplified representation of various preferred features of the present invention as disclosed herein, including, for example, specific dimensions, orientations, locations, and shapes will be determined in part by the particular intended application and use environment.

In the figures, reference numbers refer to the same or equivalent parts of the present invention throughout the several FIGS. of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover the exemplary embodiments as well as various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, an exemplary embodiment of the present disclosure will be described with reference to the accompanying drawings.

An exhaust manifold for vehicles of the present disclosure largely includes a partition 13 and a reinforcing member.

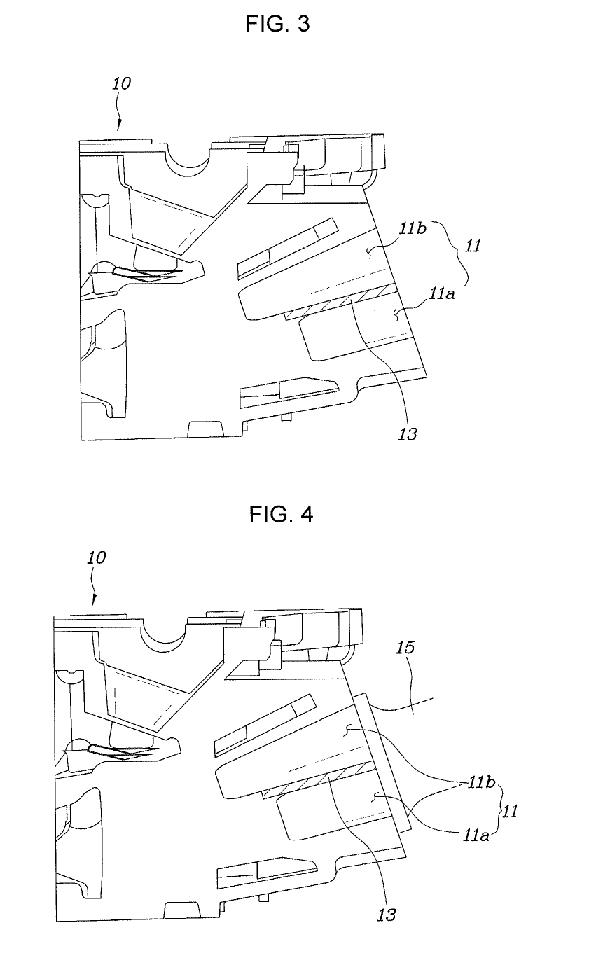

Referring to FIG. 3, specifically reviewing the present disclosure, firstly a partition 13 is formed between a first junction 11a where at least two of the runners of the exhaust manifold leading to a cylinder join and a second junction 11b where remaining runners join.

Here, the exhaust manifold of the present disclosure may be integrally formed to a cylinder head 10, and, in case of a 4-cylinder engine, a first runner and a fourth runner among the first to fourth runners of the exhaust manifold join to form the first junction 11a, and the second runner and the third runner join to form the second junction 11b. As such, two exhaust ports 11 including the first junction 11a and the second junction 11b are formed at the end portion of the runners, thereby embodying a 4-2 type exhaust structure.

In particular, the reinforcing member in the present disclosure may form the partition 13 to have higher temperature endurance than the remaining exhaust manifold.

That is, the reinforcing member may form the partition 13 to have a material of the higher temperature endurance than that of the remaining exhaust manifold

For example, the partition 13 may be formed from the stainless steel or the cast iron, and the remaining exhaust manifold may be formed from aluminum.

That is, the exhaust manifold is integrally formed to the cylinder head 10 so that the exhaust manifold and the cylinder head 10 may be formed from identical aluminum and the partition 13 may be formed from the stainless steel having a higher tension and fatigue strength at the high temperature than aluminum.

Therefore, the occurrence of the crack at the exhaust port 11 is prevented by securing the high temperature endurance of the partition 13.

In addition, in the present disclosure, the partition 13 may be formed by insert molding a sheet material of the stainless steel or the cast iron at the time of molding the exhaust manifold.

That is, at the time of manufacturing the cylinder head, by forming the partition 13 through the insert molding by utilizing the sheet material of the stainless steel or the cast iron while holding the cylinder head at the core print, a crack of the partition 13 occurring due to continuous exposure to a hot exhaust gas at a point of the exhaust port 11 of the high temperature is prevented.

Therefore, the high temperature endurance of the exhaust manifold can be improved even if a water jacket is not separately formed adjacent to the partition 13, and furthermore, the 4-2 type exhaust structure is not changed and thus the length of the runners is increased, thereby preventing the exhaust gas interference as possible so as to improve a performance in a low speed condition.

In particular, in case where the partition is formed from the aluminum as in the prior art, a thickness of the partition is thick having about 12 mm, however, in the present disclosure, the thickness of the partition may be reduced to a level of 4-5 mm due to the property of the material having the high temperature endurance, thereby increasing a sectional area of the exhaust port 11 so as to reduce an exhaust gas resistance, thereby further improving the running performance.

On the one hand, the partition 13 in the present disclosure may be formed integrally with the exhaust manifold as shown in FIG. 3.

As another exemplary embodiment, the partition 13 may be formed at a connector member 15 connected to the exhaust port 11 as shown in FIG. 4.

For example, at the time of connecting the connector member 15 to the exhaust port 11, the partition 13 formed integrally with the connector member 15 protrudes toward an inside of the exhaust port 11, so as to divide the first junction 11a and the second junction 11b.

In an exemplary embodiment of the present invention, the partition 13 may be formed monolithically with the connector member 15.

Here, the connector member 15 may be a turbine housing of a turbocharger or a post-treatment device.

That is, the partition 13 is formed integrally with the connector member of the turbocharger or the post-treatment device and the like so as to be extended to the inside of the exhaust port 11, whereby the end portion of the partition 13 is not cut off but extended into an inside of an inlet of the connector member so as to reinforce the high temperature endurance at the end portion of the partition, thereby completely removing a cause of the occurrence of the crack.

The present disclosure has effects of preventing the occurrence of the crack at the exhaust port by securing the endurance of the partition in a cylinder head integral with the exhaust manifold, of reducing the thickness of the partition, thereby increasing the sectional area of the exhaust port so as to reduce the exhaust gas resistance, as well as of increasing the length of the partition which has been given a limitation on a castability, thereby preventing the exhaust gas interference so as to improve the low and medium speed performance.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust manifold for vehicles comprising:
a partition provided between a first junction where at least two of runners of the exhaust manifold leading to a cylinder join and a second junction where remaining runners join.

2. The exhaust manifold for the vehicles of claim 1, wherein a reinforcing member is configured to form the partition to have a higher temperature endurance than a remaining exhaust manifold.

3. The exhaust manifold for the vehicles of claim 2, wherein the reinforcing member forms the partition to have a material of the higher temperature endurance than that of the remaining exhaust manifold.

4. The exhaust manifold for the vehicles of claim 3, wherein the partition is formed from a stainless steel or a cast iron, and the remaining exhaust manifold is formed from aluminum.

5. The exhaust manifold for the vehicles of claim 4, wherein the partition is formed from a sheet material of the stainless steel or the cast iron.

6. The exhaust manifold for the vehicles of claim 1, wherein the partition is formed integrally with the exhaust manifold.

7. The exhaust manifold for the vehicles of claim 1, wherein a connector member is connected to an exhaust port, and the partition is formed at the connector member to be provided between the first junction and the second junction.

8. The exhaust manifold for the vehicles of claim 7, wherein the partition is formed monolithically with the connector member.

9. The exhaust manifold for the vehicles of claim 7, wherein the connector member is a turbocharger or a post-treatment device.
